(19) United States
(12) Patent Application Publication
(10) Pub. No.: US 2009/0303315 A1
(43) Pub. Date: Dec. 10, 2009

(54) BINOCULAR DEVICE USING BEAM SPLITTER (BINO-VIEW)

(75) Inventor: Charles Nicolas Charlesworth, Newcastle-Upon-Tyne (GB)

Correspondence Address: MCKEE, VOORHEES & SEASE, P.L.C., 801 GRAND AVENUE, SUITE 3200, DES MOINES, IA, 50309-2721, US

(73) Assignee: STEREONICS LIMITED, Newcastle-Upon-Tyne (GB)

(21) Appl. No.: 12/280,651

(22) PCT Filed: Feb. 22, 2007
(86) PCT No.: PCT/GB07/00609

§ 371 Date: Aug. 25, 2008

(30) Foreign Application Priority Data
Feb. 23, 2006 (GB) 0603588.5
Jun. 7, 2006 (GB) 0611178.5

(51) Int. Cl. G02B 27/22; G02B 27/02; G02B 7/12; H04N 7/18

(52) U.S. Cl. 348/61; 359/480; 359/482; 359/473; 348/E07.085

(57) ABSTRACT

A binocular device including two ocular units and directing means to allow a user to view a display, the display being moveable when the distance between the ocular units is varied for interocular adjustment to maintain focus on the display. Instead of the display being movable, focus can be maintained by the inclusion in the directing means of optical relays for transmitting parallel light. In a further embodiment, a sensor is provided, the output of which is directed for viewing via the ocular units. In yet another embodiment, image capture means are provided for recording the image from the ocular units.

The invention to which this application relates is a binocular device with a single display provided for viewing by both eyes of a user.

Binocular devices are those which are adapted to allow use therewith of both eyes by a user. Some of these devices are stereoscopic, providing a user's eyes with slightly offset views so that the user sees a three-dimensional view of an object.

Recent technological developments have allowed close-to-eye viewing devices to be constructed, typically in a form which can be worn like spectacles, and which may include two displays, one for each eye. However, it is relatively expensive to produce an article with two displays, and each display requires a power supply which can make such devices heavy and uncomfortable to wear due to the additional weight, and may require a more complicated mounting.

Prior art binocular viewing devices are sometimes provided with adjustment means to allow the user to adjust the spacing between the displays for comfort, to match the interocular spacing, i.e. the distance between the user's eyes. For example, the two ocular units of a pair of LCD glasses may be slid apart to adjust the spacing between the ocular units. There is no change in path length between the user's eyes and the displays, as the movement only affects the distance between the ocular units and not the distance between each display and the respective eye. However, where a single display is provided in such devices, the path length changes when the spacing of the ocular units is adjusted, such that the display is no longer in focus. It is important that the display viewed by each eye of the user is substantially the same, as even a small variation can cause headaches and the like.

An aim of the present invention is to provide a binocular device for viewing a single display which does not require a re-focusing after interocular adjustment is performed.

A further aim of the invention is provide a binocular device capable of capturing three-dimensional images and/or video via a single sensor.

In a first aspect of the invention, there is provided a binocular device including:
two ocular units;
adjustment means to allow the distance between the ocular units to be varied for interocular adjustment;
a display for viewing via the ocular units;
directing means to direct the light from the display along a first path via one of the ocular units, and a second path via the other ocular unit;
characterised in that when the distance between the ocular units is adjusted, the display is moved to maintain focus on the display.

In one embodiment a single display is viewed by both eyes of the user.

Typically, when the display is moved the relative lengths of the paths do not substantially change.

In one embodiment the display is mounted centrally between the two ocular units inside the binocular device.

In one embodiment the directing means is mounted substantially centrally between the two ocular units. This equidistant spacing helps the optical path lengths to be maintained during interocular adjustment.

In a further embodiment the display is mounted offset relative to at least one of the ocular units. Typically the display is located to the side of the user's head when in use, and may be in any orientation.

In one embodiment, the light from the display is directed substantially perpendicular to the user's line of sight.

In one embodiment, the display is mounted substantially perpendicularly to the user's eyes.

In one embodiment the directing means includes any or any combination of offset lenses, beam-split prisms, prisms, plain mirrors, half-silvered mirrors, polarising mirrors, and/or the like to direct light from the display to both eyes simultaneously.

In one embodiment the one or more lenses adjacent to the display are so constructed such that the image beams they produce are substantially parallel, and no additional focusing is required when interocular spacing adjustment is made. Thus a system of mirrors, prisms and/or lenses can be used to direct light in an optical relay or periscope-like fashion and as the light beams are substantially parallel, no re-focusing is required when the distance between the ends of the optical relay is changed. In this embodiment, the display does not therefore need to be moved to maintain focus, although the image viewed may appear to change in size as the user interocularly adjusts the device. A mechanism can also be provided to maintain sharpness, such as by linking the interocular spacing adjustment with adjustment of the lenses.

In one embodiment filters are provided to equalise the intensity of the light on the first and second paths.

In one embodiment the display provides alternate images for each eye to generate a three-dimensional view.

In one embodiment liquid crystal (LC) shutter glass units are placed in the left and right light paths between the directing means and the user's eyes to alternately allow and restrict the view of the display. Typically the left and right units are synchronised to left and right images on the display. Other light restricting elements can be used for the same effect, such as polarised filters, electro-chemical filters, piezoelectric mechanisms, electro-mechanical and/or the like.

In an alternative embodiment the directing means directs light to the left or right eye alternately. Typically the directing means in this embodiment is a rotating unit with a shutter system to limit or direct the passage of light from the display to the left or right eye alternately. Typically the rotating unit is electronically controlled and rotation speed is synchronised to the showing of left and right images on the display for generating a three-dimensional view.

In one embodiment the adjustment means allows the distance between the ocular units to be varied. Typically the ocular units are slidably connected together.

In one embodiment the adjustment means comprises a rack and pinion arrangement to provide simultaneous and opposite movement of the ocular units. Alternatively the ocular units can be moved independently, such that the user can view the display with either or both ocular units and/or move them out of their line of sight when not in use.

In this embodiment the display is laterally movable to maintain light path length as the ocular units are moved towards and away from each other. Thus as the ocular units are moved closer together, the display is movable further away from the user's eyes to maintain the path length of the light and prevent the path length shortening which would affect focusing.

Typically the display is mechanically connected to the ocular units such that movement of the ocular units leads to lateral movement of the display to maintain path length, and thus focus, automatically.

In a further embodiment focusing means are provided by lenses mechanically connected to the ocular units such that rotation of the ocular units and/or movement of the lenses adjusts the focus on the display automatically when the light path length changes.

Typically the focusing means are mechanically connected to the adjustment means such that when the distance between the ocular units is adjusted the focus on the display is maintained. This is of particular importance to embodiments in which the two path lengths are unequal due to the offset positioning of the display and change when the distance between the ocular units is adjusted. The focusing means allow the focus on the display to be maintained.

In a yet further embodiment the device is provided with additional mirrors and/or prisms which cause the light path length to be maintained as the ocular units are moved towards and away from each other. For example a series of mirrors can be provided such that light is directed onto a first mirror when the ocular units are in a first position, and a second mirror when the ocular units are in a second position, the light path length being substantially the same in both cases.

In one embodiment the adjustment means allows the angle between the ocular units to be varied. In this embodiment the path length does not typically vary as the ocular units are adjusted.

In this embodiment mirrors and/or prisms are rotationally mounted and mechanically connected to the ocular units to automatically maintain the view of the display by the user as the angle between the ocular units is adjusted. Typically the display is fixed in this embodiment as no counter-rotation of the display is required to maintain the orientation of the display.

Typically the ocular units are pivotally connected together. Typically the lateral axis of the display is shared with the common pivotal axis of the ocular units.

Alternatively the ocular units are pivotally connected to opposite ends of a bridge portion provided therebetween. Typically the pivotal axis of each ocular unit is parallel to the rotational axis of the mirror or prism associated therewith. Typically the ocular unit moves through twice the angle of the mirror or prism associated therewith to maintain the view of the display by the user.

Typically the binocular device can be adapted for heads-up display, head-mounted system, close to eye viewing system, electronic image viewing, binoculars, or microscopes.

Where the ocular units are pivotally mounted in head-mounted system, the vertical position of the ocular units change with respect to the user as the angle between the ocular units is adjusted. Typically in this arrangement, the binocular device includes vertical positioning means.

Typically the display is electronic, such as STN, TFT, OLED, and/or the like.

In one embodiment detection means are provided for detecting and/or limiting the brightness level of the display.

It will be appreciated by those skilled in the art that OLED displays in particular suffer from a decay in brightness over a period of time. The greater the display brightness, the shorter the usage life. Most displays are capable of brightness levels far greater than actually required by the user for satisfactory use in most normal viewing conditions. In addition, if the brightness level is too high, damage can be caused to the user's eyes.

Typically the brightness is limited based on usage time and usage brightness during said usage time. Thus the maximum brightness level is limited during the early part of the display lifetime, thus extending the lifetime of the display.

In one embodiment a blank or white image is generated on the display, the brightness of which provides reference data during a calibration cycle to determine the maximum brightness level. The ambient light illumination can be measured when the display is not illuminated.

Typically the detection means include one or more photo-diode detectors inside and/or outside the device for measuring the brightness level of the display and/or ambient light.

In one embodiment the opacity of the housing in which the display is situated and/or the contents thereof is variable. Typically at least part of the housing is made from photo-reactive glass or includes liquid crystal glass.

Thus, under low ambient light conditions, at least part of the housing thus becomes transparent, providing the user with greater peripheral vision to prevent the user losing their balance or becoming otherwise disorientated. However, under bright ambient light conditions the housing becomes progressively more opaque as the ambient light brightness level increases, so that the display is still clearly visible.

Advantageously the user therefore benefits from the maximum possible peripheral vision without adversely affecting the viewing experience.

It will be appreciated by those skilled in the art that where a single display is provided for viewing by both eyes of the user, the brightness level of said display may need to be twice that required by embodiments in which two displays are provided. Thus being able to adjust the brightness level to the minimum necessary optimises the lifetime of the display.

In one embodiment the binocular device is provided with imaging means thereon for generating an image on the display.

Typically the imaging means are any or any combination of CMOS, CCDs and/or the like.

In one embodiment the binocular device is provided with illumination means thereon to illuminate the subject of the imaging means. Typically the device is provided with polarised filters to prevent feedback from the illumination means.

In a further embodiment, capture means are provided for capturing images from the display and/or imaging means. Typically, further directing means are provided to direct at least a portion of the light to the capture means. Thus images can be captured digitally while a user views the images optically.

Typically the orientation of the display and/or imaging means and/or capture means is unaffected by movement of the ocular units.

Typically the capture means is an electronic camera for recording images and/or video onto a recordable medium, and may be provided with a digital zoom function. Typically a visible indication of the recording size is provided, and the recording size indication can be linked to the zoom function.

Typically the indication is a frame within the view of the user. Thus the user views the whole display and can record for example the central portion, or another part of the display as determined by the user. Alternatively the indication is numerical to indicate the magnification of the zoom function.

In one embodiment the zoom function can be adjusted by adjusting the path length of light from the display.

In one embodiment control means are provided to control the zoom and/or resolution of the recorded images and/or video according to the indication of recording size. If for example, free space on the recordable medium was limited, the recording size and/or resolution could be automatically restricted as the free space was reduced as images and/or video was recorded.

Lower resolution recordings take up less storage space and hence extend the recording time available to the user. Activation of said mechanism may be provided automatically or by direct action of the user, and typically occurs in response to a warning of low storage space, further typically according to a user adjustable parameter.

Typically the capture means can output the images and/or video to the display for viewing by the user.

In a second aspect of the invention, there is provided a binocular device including:
two ocular units;
adjustment means to allow interocular adjustment;
a sensor, the output of which provides views to both eyes of a user via the ocular units;
characterised in that directing means are provided to direct the sensor output along a first path via one of the ocular units, and a second path via the other ocular unit.

In one embodiment the sensor is capable of detecting infra-red radiation, such that the device can be used for night vision.

Typically the sensor is connected to recording means for recording images and/or video, and may be provided with a zoom function as hereinbefore described.

In a third aspect of the invention, there is provided a binocular device including:
left and right ocular units;
adjustment means to allow interocular adjustment;
capture means to capture left and right images and/or video from respective left and right ocular units;
characterised in that directing means are provided to direct the light from the left ocular unit along a first path onto said capture means, and the light from the right ocular unit along a second path onto said capture means.

Typically the orientation of the capture means is unaffected when the ocular units ate moved using the adjustment means. Typically the capture means is mounted centrally between the ocular units.

In one embodiment the directing means directs light from the left and right ocular units alternately onto the capture means.

In one embodiment the directing means is a rotating unit with an electronically controlled shutter system to limit or direct the passage of light from the left or right ocular units to the capture means alternately.

Typically the left and right images captured allow the generation of a three-dimensional view therefrom.

In an alternative embodiment mirrors and/or prisms and/or shutter systems between the objectives and the directing means alternately restrict light reaching the capture means from the respective ocular units.

In a fourth aspect of the invention, there is provided a binocular device including:
two ocular units;
adjustment means to allow the distance between the ocular units to be varied for interocular adjustment;
a display for viewing via the ocular units;
directing means to direct the light from the display along a first path via one of the ocular units, and a second path via the other ocular unit;
characterised in that the directing means includes one or more optical relays such that the focus on the display is maintained when the distance between the ocular units is adjusted.

In one embodiment the optical relays include one or more lenses so constructed so as to transmit substantially parallel light beams thereby. Thus the beams of light between the ends of the optical relay are parallel so that the focus on the display is unaffected when the distance between the ends is adjusted.

In one embodiment, one end of an optical relay is formed as part of an eyepiece. Typically the eyepiece can be moved to compensate for interpupillary distance.

Specific embodiments of the invention are now described wherein:

FIG. 1 illustrates a schematic view of components of a prior art binocular device.

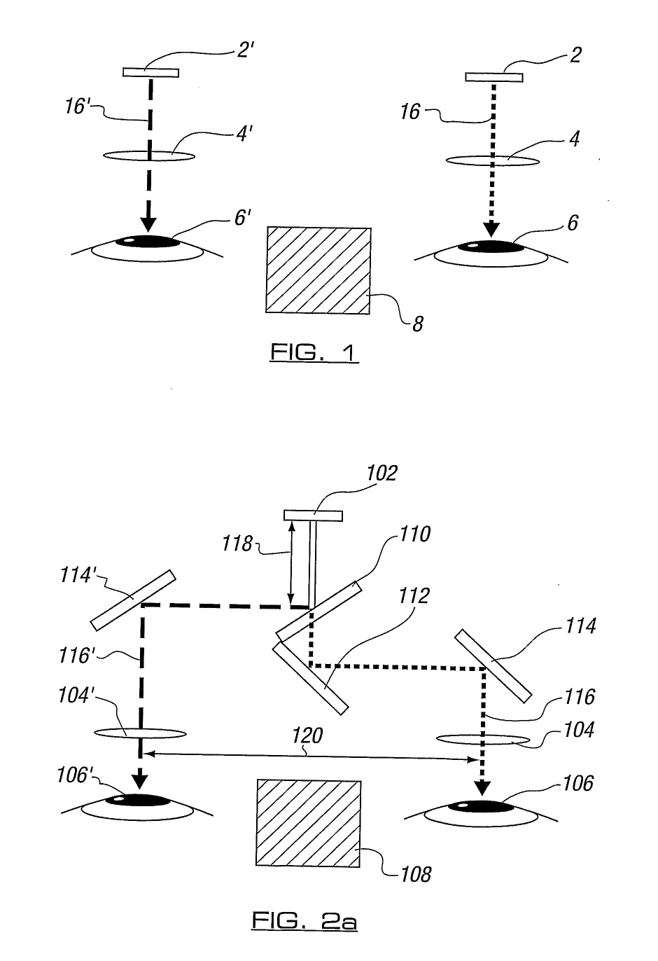

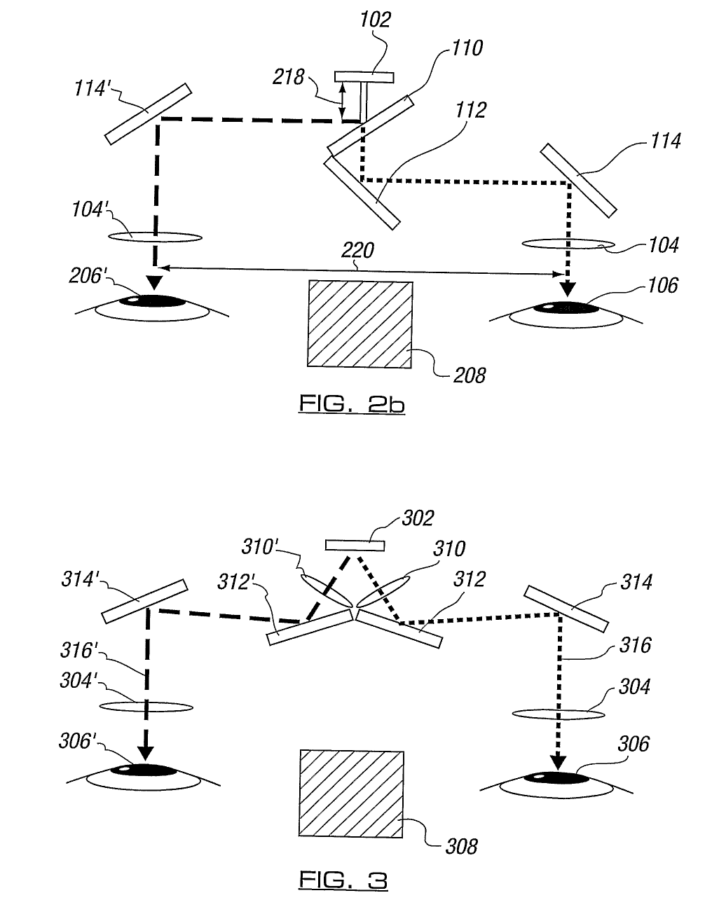

FIGS. 2a-b illustrates a schematic view of components of a binocular device in accordance with a first embodiment of the invention.

FIG. 3 illustrates a schematic view of components of a binocular device in accordance with a second embodiment of the invention.

FIGS. 4a-b illustrates a partial schematic view of a binocular device in accordance with the embodiment of FIGS. 2a-b.

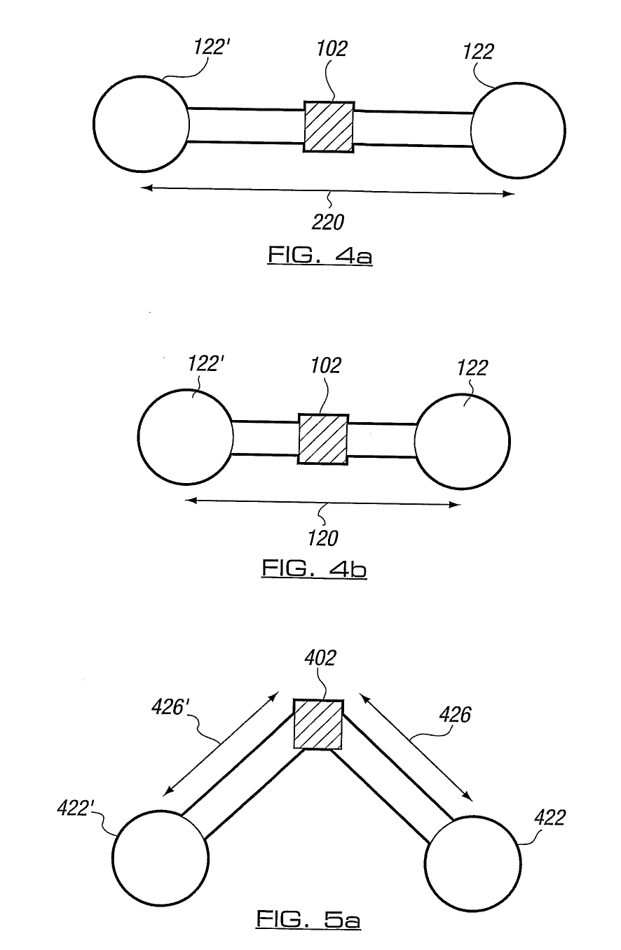

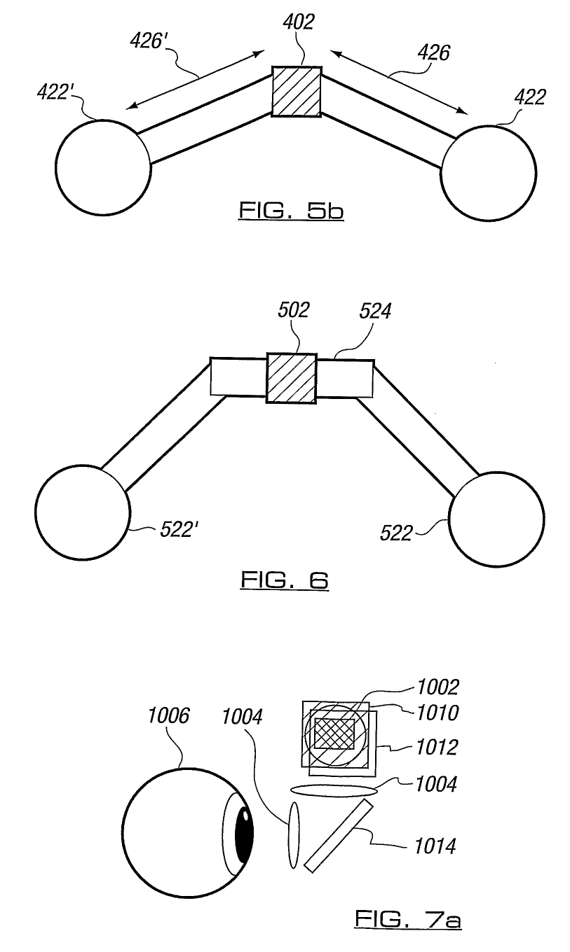

FIGS. 5a-b illustrates a partial schematic view of a binocular device in accordance with a third embodiment of the invention.

FIG. 6 illustrates a partial schematic view of a binocular device in accordance with a fourth embodiment of the invention.

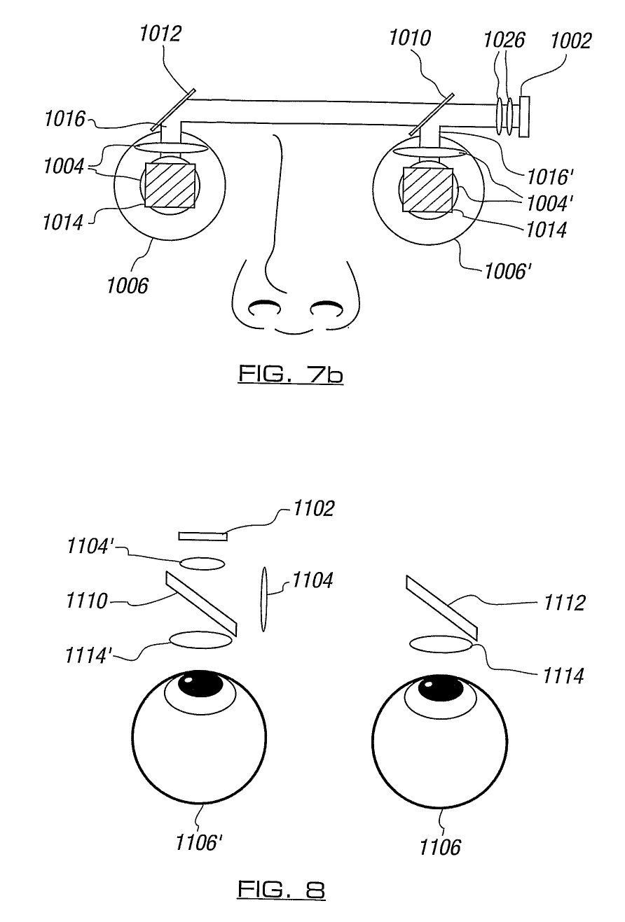

FIG. 7 illustrates a schematic view of the binocular device according to a fifth of the invention (a) from the side (b) from the front.

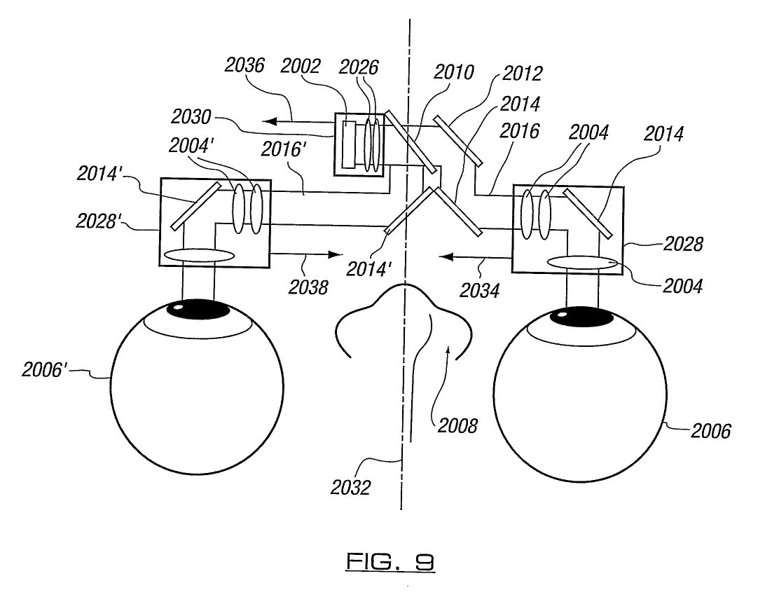

FIG. 8 illustrates a schematic view of a sixth embodiment of the invention from above.

FIG. 9 illustrates a schematic view of a seventh embodiment of the invention from above.

With reference to FIG. 1, there is illustrated some of the internal components of a binocular device in the form of LCD glasses according to the prior art, in which two display screens are provided 2, 2′ which are viewed by respective eyes 6, 6′ of the user. The device is supported by the nose 8 of the user, and each of the views of the screens can be focussed with respective lenses 4, 4′. Thus light 16′ from the left display 2′ is viewed by the left eye 6′, the left display 2′ operating independently of the right display 2 which directs light 16 therefrom to the right eye 6. As noted above, to produce a device with two displays in this way is expensive.

With reference to FIG. 2, there is illustrated some of the internal components of a binocular device in accordance with a first embodiment of the invention. A single display 102 is provided which emits light that passes through directing means in the form of a beam splitter 110 to direct about half the light along a first path 116′ and the rest along a second path 116 via respective ocular units (not shown). Thus light is reflected towards the left and right ocular units by the beam splitter 110 and a mitror 112 situated behind the beam splitter respectively.

Mirrors 114′, 114 and lenses 104′, 104 then direct the light along the respective paths 116′, 116 to respective eyes 106′, 106 of the user.

Referring additionally to FIGS. 4a-b, there is shown the left and right ocular units 122′, 122 which can be moved apart or towards each other, to adjust the interocular spacing as indicated by arrows 120, 220 for the eyes 206′, 206 of a different user. The display 102 in this example is connected to the interocular adjustment mechanism, such that when the ocular units are moved apart from the position shown in FIG. 2a to the position shown in FIG. 2b, the display 102 is also moved, in this example from a first position as indicated by arrow 118 to a position 218 closer to the beam splitter 110, to maintain the overall path lengths between the display 102 and eyes of the user.

With reference to FIG. 3, a further embodiment of the invention is shown and similar reference numerals are used where appropriate. Additional lenses 310, 310′ and mirrors 312, 312′ are provided to direct light from a single display 302 along the right and left paths 316, 316′ to the user's respective eyes 306, 306′.

Referring to FIGS. 5a-b, a further embodiment of the invention is shown in which the ocular units 422, 422′ are pivotally connected, and the common pivotal axis is the same as the lateral axis of the display 402. Thus as the angle between the ocular units is adjusted, from the position shown in FIG. 5a to that shown in FIG. 5b, the path lengths 426, 426′ of the light between display and user are unaffected.

With reference to FIG. 6 there is shown a yet further embodiment of the invention, similar to that described in FIGS. 5a-b except that the display is mounted in a bridge portion 524, and the ocular units 522, 522′ are pivotally connected to opposite ends of the bridge portion. As hereinabove described, as the angle between the ocular units is adjusted, the path lengths of the light between display and user are unaffected.

With reference to FIGS. 7a-b, there is illustrated a binocular device in which a single display 1002 is provided which emits light that passes through directing means in the form of a beam splitter 1010 to direct about half the light along a first path 1016′ and the rest along a second path 1016 via respective ocular units (not shown).

The display 1002 is mounted slightly above, in front and perpendicular to the user's eyes 1006, 1006′ such that the light emitted therefrom passes across the forehead of the user, parallel to the user's eyes, and can be then reflected down and then towards the user's eyes.

Thus light is reflected towards the left ocular unit by a beam splitter 1010, which is situated above the user's left eye 1006′, and the right ocular unit via a mirror 1012 situated to the side of the beam splitter, above the user's right eye 1006.

Mirrors 1014′, 1014 and lenses 1004′, 1004 then direct the light along the respective paths 1016′, 1016 to respective eyes 1006′, 1006 of the user. Additional lenses 1026 may be provided adjacent the display to help focus the beam of light emitted therefrom.

It will be appreciated that the display could be positioned at the same height as the user's eyes, such that the light emitted from the display passes across the user's eyes rather than above the user's eyes, such that a simpler arrangement can be used in which secondary mirrors 1014, 1014′ are unnecessary.

Thus a device is provided in which a single display provides a view to both eyes of a user, and as the display is mounted to the side of the user's head, it does not extend outwardly in front of the user compared to prior art devices, and the device is therefore less cumbersome to the user. As the display is situated closer to the user and is one of the heavier components, the device exerts less pressure on the user's head when worn than if the display was situated at a greater distance.

A further embodiment is indicated in FIG. 8 in which the display 1102 is positioned in the line of sight of one of the user's eyes 1106′, and light is guided via lenses 1104′, 1104, 1114′, 1114, at least one mirror 1112, and a beam splitter 1110 into both eyes 1106, 1106′ as hereinabove described. This embodiment is therefore more compact and lighter than a device with two displays.

A further embodiment is indicated in FIG. 9 there is illustrated a binocular device in which a single display 2002 is mounted in a moveable unit 2030, emitting light perpendicular to the user's line of sight. The light passes through directing means in the form of a beam splitter 2010 to direct about half the light along a first path 2016′ and the rest along a second path 2016 via respective ocular units 2028′, 2028.

Mirrors 2014′, 2014 and lenses 2004′, 2004 direct the light along the respective paths 2016′, 2016 to respective eyes 2006′, 2006 of the user.

The beam splitter 2010 is situated half-way between the user's eyes when the device is worn, typically defined by a line 2032 extending from the user's nose 2008, and ensures that the optical path length to each eye is the same.

Thus as one optical unit 2028 is moved by the user in one direction for interocular adjustment, as indicated by arrow 2034, moveable unit 2030 including the display 2002 is moved by an equal amount in the same direction, as indicated by arrow 2036, to maintain the path length 2016 between the display 2002 and the user's eye 2006. At the same time, the other optical unit 2028′ is moved by an equal amount in the opposite direction, as indicated by arrow 2038, to maintain the same path length 2016′ between the display 2002 and the user's other eye 2006′. A rack and pinion arrangement (not shown) can be provided to facilitate these movements.

Thus advantageously the binocular device can be adjusted by a user to match their interocular distance while maintaining the path length of light between the user's eyes and the display to avoid focusing issues. As the display extends sideways, the device is less cumbersome than if it extended directly away from the user.

Additional lenses 2026 may also be provided adjacent the display forming optical relays with lenses 2004′, 2004 in the optical units such that the focus on the display is maintained when moving the ocular units, and thus movement of the display is not required when optical relays are used.

In use, a person can wear the binocular device to view the display therein, and adjust the distance between the ocular units without having to manually also adjust focus, as this occurs automatically as hereinbefore described. The user views the single display with both eyes, the display providing video or images to each eye via the beam splitter, prisms and/or mirrors which direct and/or reflect light within the device from the display to the user's eyes.

The device can be provided with imaging means such as a CCD, connected to the display to provide images and/or video thereto. The device can also be provided with capture means such as an electronic camera for recording the images and/or video from the display, typically using a further beam splitter, prisms and/or mirrors to reflect part of the light from the display to avoid interfering with the view to the user. Thus the binocular device can be worn like a pair of glasses and used as a video camera, allowing the user to record the view provided to his eyes.

In a further embodiment, the user views three-dimensional images or video, as each eye is provided with the appropriate views of the display to generate the three-dimensional representation. The device of this embodiment can also be used to capture images and/or video stereoscopically to allow a three-dimensional view to be created therefrom.

It will be appreciated that a interocularly-adjustable binocular device can be provided with or without a display, such that the user views an object via the normal optics of the ocular units, with capture means such as a camera, which can be used to capture images and/or video of objects viewed, and if the interocular spacing is adjusted, the orientation and/or focus of the capture means does not need to be adjusted by the user.

It will be appreciated by persons skilled in the art that the present invention may also include further additional modifications made to the device which does not affect the overall functioning of the device.

1. A binocular device including:
two ocular units;
adjustment means to allow the distance between the ocular units to be varied for interocular adjustment;
a display for viewing via the ocular units;
directing means to direct the light from the display along a first path via one of the ocular units, and a second path via the other ocular unit;
characterised in that when the distance between the ocular units is adjusted, the display is moved to maintain focus on the display.

2. A binocular device according to claim 1 wherein a single display is provided for viewing by both eyes of the user.

3. A binocular device according to claim 1 wherein when the display is moved the relative lengths of the paths do not substantially change.

4. A binocular device according to claim 1 wherein the adjustment means provides simultaneous equal and opposite movement of the ocular units

5. A binocular device according to claim 1 wherein the adjustment means comprises a rack and pinion arrangement.

6. A binocular device according to claim 1 wherein the display and/or directing means is mounted centrally between the two ocular units.

7. A binocular device according to claim 1 wherein the display is mounted offset relative to at least one of the ocular units.

8. A binocular device according to claim 7 wherein the display is located to the side of the user's head when in use.

9. A binocular device according to claim 7 wherein the light from the display is emitted substantially perpendicular to the user's line of sight.

10. A binocular device according to claim 7 wherein the display is mounted substantially perpendicularly to the user's eyes.

11. A binocular device according to claim 1 wherein the directing means includes any or any combination of offset lenses, beam-split prisms, plain mirrors, half-silvered mirrors, and/or polarising mirrors to direct light from the display to both eyes simultaneously.

12. A binocular device according to claim 1 wherein one or more lenses are provided adjacent to the display such that the image beams derived therefrom are substantially parallel.

13. A binocular device according to claim 1 wherein filters are provided to equalise the intensity of the light on the paths.

14. A binocular device according to claim 1 wherein the display provides alternate images for each eye to generate a three-dimensional view.

15. A binocular device according to claim 14 wherein light restricting elements are placed in the left and right light paths between the directing means and the user's eyes to alternately allow and restrict the view of the display.

16. A binocular device according to claim 14 wherein the directing means directs light to the left or right eye alternately.

17. A binocular device according to claim 1 wherein focusing means are associated with the adjustment means such that that if a light path length changes, the focusing means automatically adjusts the focus on the display.

18. A binocular device according to claim 1 wherein imaging means are provided for generating an image on the display.

19. A binocular device according to claim 18 wherein illumination means are provided to illuminate the subject of the imaging means.

20. A binocular device according to claim 18 wherein capture means are provided for capturing images and/or video from the display and/or imaging means onto a recordable medium.

21. A binocular device according to claim 20 wherein control means are provided to control the resolution of the images and/or video being captured and/or a zoom function according to the size of the images and/or video already captured on the recordable medium.

22. A binocular device according to claim 1 wherein detection means are provided for detecting and/or limiting the brightness level of the display.

23. A binocular device according to claim 1 wherein the device is provided with a housing, at least a part of which and/or the contents thereof is variable in opacity to improve peripheral vision depending on the ambient light level and/or brightness level of the display.

24. A binocular device including:
two ocular units;
adjustment means to allow interocular adjustment;
a sensor, the output of which provides views to both eyes of a user via the ocular units;
characterised in that directing means are provided to direct the sensor output along a first path via one of the ocular units, and a second path via the other ocular unit.

25. A binocular device according to claim 24 wherein the sensor is capable of detecting infra-red radiation.

26. A binocular device according to claim 24 wherein the sensor is connected to recording means for recording images and/or video, and/or means for playing back recorded images and/or video.

27. A binocular device including:
left and right ocular units;
adjustment means to allow interocular adjustment;
capture means to capture left and right images and/or video from respective left and right ocular units;
characterised in that directing means are provided to direct the light from the left ocular unit along a first path onto said capture means, and the light from the right ocular unit along a second path onto said capture means.

28. A binocular device according to claim 27 wherein the directing means directs or restricts light from the left and right ocular units alternately onto the capture means to allow the generation of a three-dimensional view therefrom.

29. a binocular device including:
two ocular units;
adjustment means to allow the distance between the ocular units to be varied for interocular adjustment;
a display for viewing via the ocular units;
directing means to direct the light from the display along a first path via one of the ocular units, and a second path via the other ocular unit;
characterised in that the directing means includes one or more optical relays such that the focus on the display is maintained when the distance between the ocular units is adjusted.

30. A binocular device according to claim 29 wherein the optical relays include one or more lenses so constructed so as to transmit substantially parallel light beams thereby.
